(19) United States
(12) Patent Application Publication
(10) Pub. No.: US 2025/0036166 A1
(43) Pub. Date: Jan. 30, 2025

(54) ADAPTIVE SHELL FOR EXTERNAL TABLET KEYBOARD

(71) Applicant: Yuexin GUO, Longgang District (CN)

(72) Inventor: Yuexin GUO, Longgang District (CN)

(21) Appl. No.: 18/227,293

(22) Filed: Jul. 27, 2023

(51) Int. Cl. G06F 1/16; H01F 7/02

(52) U.S. Cl. CPC G06F 1/1669; H01F 7/02

(57) ABSTRACT

The present utility model relates to an adaptive shell for an external tablet keyboard, including an adaptive shell body, a first magnetic suction region and a second magnetic suction region are arranged on two short side edges of the adaptive shell body, respectively; and the adaptive shell body is further provided with a third magnetic suction region and/or a fourth magnetic suction region. According to the present utility model, the adaptive shell is used as an intermediate connecting component; the first magnetic suction region and the second magnetic suction region are arranged on the short side edges; and based on this, the third magnetic suction region is additionally arranged on the long side edge of the adaptive shell, thereby implementing the use of the tablet computer on the existing external tablet keyboard in both a landscape mode and a portrait mode.

### BACKGROUND OF THE INVENTION

The present utility model relates to the field of electronic products, in particular to, an adaptive shell for an external tablet keyboard.

The external tablet keyboard is a peripheral device that is connected to a tablet computer via Bluetooth and can type texts. Generally, an external tablet keyboard, such as a brand of magic keyboard, is provided with a support plate for fixing a tablet in a magnetic suction manner. Magnetic suction components (such as magnets) are arranged on only left and right sides of the support plate of the magic keyboard and are connected to magnetic suction components inside two ends of short edges of the tablet computer, and then the tablet computer is fixed to the support plate of the magic keyboard in a landscape mode.

When the tablet computer is in use, it is impossible to add magnets in other parts of the interior due to the limitations of its internal structure. As a result, the tablet computer can only be magnetically sucked onto the support plate of the magic keyboard in the landscape mode. If a user needs to use the tablet computer on the magic keyboard in a portrait mode, it cannot be implemented.

Therefore, how to overcome the limitations of the tablet computer on the magic keyboard in a magnetic suction state has become an urgent problem to be solved.

### BRIEF SUMMARY OF THE INVENTION

To overcome the limitations of an existing tablet computer on a magic keyboard in a magnetic suction state, the present utility model provides an adaptive shell for an external tablet keyboard.

A technical solution of the present utility model is as follows:

An adaptive shell for an external tablet keyboard includes an adaptive shell body, where a back surface of the adaptive shell body is connected to a support plate of an external tablet keyboard in a magnetic suction manner; a first magnetic suction region and a second magnetic suction region are arranged on two short side edges of the adaptive shell body, respectively;
the adaptive shell body is further provided with a third magnetic suction region and/or a fourth magnetic suction region, the third magnetic suction region being arranged on one long side edge of the adaptive shell body, the fourth magnetic suction region being arranged in a middle of the adaptive shell body;
when a tablet computer is magnetically sucked onto the external tablet keyboard in a landscape mode by the adaptive shell body, the first magnetic suction region and the second magnetic suction region are correspondingly connected to magnetic suction components on a left side and a right side of the support plate, respectively, or the fourth magnetic suction region is connected to a magnetic suction component in a middle of the support plate; or
when a tablet computer is magnetically sucked onto the external tablet keyboard in a portrait mode by the adaptive shell body, the third magnetic suction region is connected to a magnetic suction component on a right side of the support plate, or the fourth magnetic suction region is connected to a magnetic suction component in a middle or on a right side of the support plate.

With the above technical solution, the present utility model has the following beneficial effects:

According to the present utility model, the adaptive shell is used as an intermediate connecting component to implement the adsorptive connection between a tablet computer and an external keyboard; the first magnetic suction region and the second magnetic suction region are arranged on the short side edges, namely, a left side and a right side of the adaptive shell, respectively; and based on this, the third magnetic suction region is additionally arranged on the long side edge of the adaptive shell and can be connected to the right side of the support plate of the external keyboard in a magnetic suction manner, such that the adaptive shell can also be connected to the external keyboard in a magnetic suction manner in a vertical state, and then the adaptive shell can be magnetically sucked onto the support plate in both a landscape mode and a portrait mode, thereby implementing the use of the tablet computer on the existing external tablet keyboard in both the landscape mode and the portrait mode.

According to the present utility model, the fourth magnetic suction region is additionally arranged to adapt to the external keyboard with the magnetic suction component arranged in the middle of the support plate, which improves the applicability of the adaptive shell according to the present utility model, such that the adaptive shell according to the present utility model can meet the requirements of various external keyboards;
furthermore, the fourth magnetic suction region adopts a magnetic sheet distribution of a square matrix, and the gap is reserved between the adjacent two of the magnetic sheets, to adjust a fixed magnetic suction height of the tablet computer on the support plate.

### BRIEF DESCRIPTION OF THE DRAWINGS

FIG. 1 is a schematic structural diagram of Embodiment 1 of the present utility model;

FIG. 2 is a schematic diagram that an adaptive shell is magnetically sucked onto an external tablet keyboard in a landscape mode in Embodiment 1;

FIG. 3 is a schematic diagram that an adaptive shell is magnetically sucked onto an external tablet keyboard in a portrait mode in Embodiment 1;

FIG. 4 is a schematic diagram that the present utility model is applied to a tablet computer;

FIG. 5 is a schematic structural diagram of Embodiment 2 of the present utility model;

FIG. 6 is a schematic diagram that an adaptive shell is magnetically sucked onto an external tablet keyboard in a portrait mode in Embodiment 2;

FIG. 7 is a schematic structural diagram of Embodiment 3 of the present utility model; and

FIG. 8 is a schematic diagram that an adaptive shell is magnetically sucked onto an external tablet keyboard in a portrait mode in Embodiment 3.

In the drawings: 1. adaptive shell body;
11. first magnetic suction region; 111. first L-type magnetic sheet group; 112. first rectangular magnetic sheet group;
12. second magnetic suction region; 121. second C-type magnetic sheet group 122. second L-shaped magnetic sheet group; 123. vertical double-point magnetic sheet group; 124. second rectangular magnetic sheet group;
13. third magnetic suction region; 131. third C-type magnetic sheet group; 132. third L-type magnetic sheet group; 133. horizontal double-point magnetic sheet group; 134. third rectangular magnetic sheet group; 135. auxiliary magnetic sheet region;
14. fourth magnetic suction region;
15. stylus slot;
2. tablet computer;
3. stylus;
4. external tablet keyboard; and 41. support plate.

### DETAILED DESCRIPTION OF THE INVENTION

To better understand the objective, the technical solution and technical effects of the present utility model, the present utility model is further described below in conjunction with the accompanying drawings and the embodiments. It is also stated that the embodiments described below are merely used to explain the present utility model, but not to limit the present utility model.

### Embodiment 1

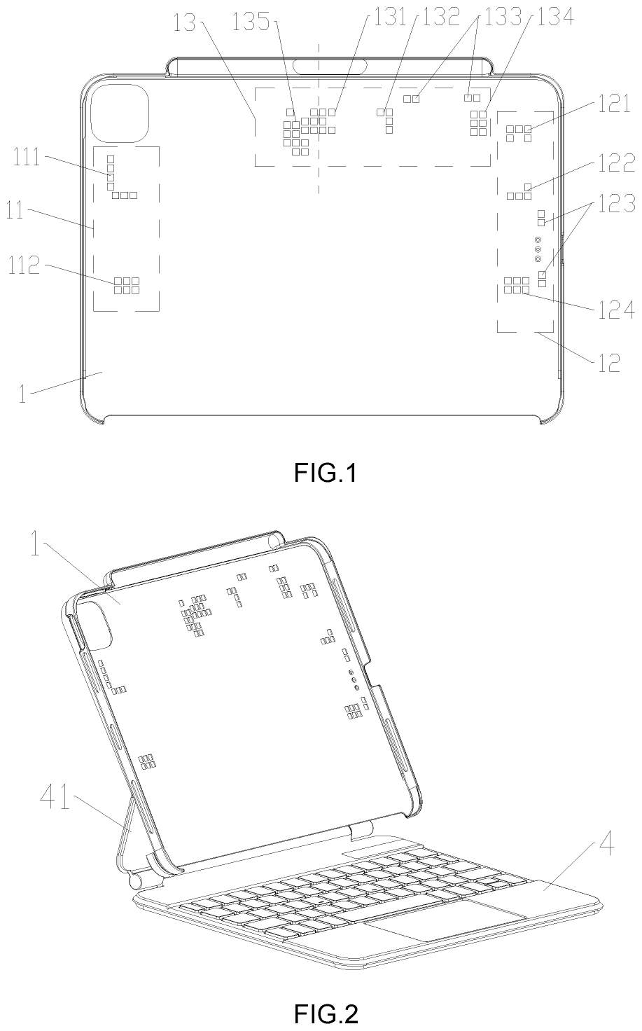

As shown in FIG. 1 to FIG. 3, an adaptive shell for an external tablet keyboard includes an adaptive shell body 1, where the adaptive shell body 1 is sleeved on a back surface of a tablet computer 2, and a back surface of the adaptive shell body 1 is connected to a support plate 41 of an external tablet keyboard 4 in a magnetic suction manner; a first magnetic suction region 11 and a second magnetic suction region 12 are arranged on two short side edges of the adaptive shell body 1, respectively; the adaptive shell body 1 is further provided with a third magnetic suction region 13, the third magnetic suction region 13 being arranged on one long side edge of the adaptive shell body 1; when the tablet computer 2 is magnetically sucked onto the external tablet keyboard 4 in a landscape mode by the adaptive shell body 1, the first magnetic suction region 11 and the second magnetic suction region 12 are correspondingly connected to magnetic suction components on a left side and a right side of the support plate 41, respectively; or when the tablet computer 2 is magnetically sucked onto the external tablet keyboard 4 in a portrait mode by the adaptive shell body 1, the third magnetic suction region 13 is connected to a magnetic suction component on a right side of the support plate 41.

In this embodiment, the first magnetic suction region 11 is provided with two magnetic sheet groups including a first L-shaped magnetic sheet group 111 located above and a first rectangular magnetic sheet group 112 located below. The first L-shaped magnetic sheet group 111 is provided with four magnetic sheets vertically and three magnetic sheets horizontally, namely, a total of seven magnetic sheets; and the first rectangular magnetic sheet group 112 includes magnetic sheets distributed in two rows and three columns, namely, a total of six magnetic sheets. The first L-shaped magnetic sheet group 111 and the first rectangular magnetic sheet group 112 are in one-to-one correspondence with magnetic suction components in the left side of the support plate 41.

In this embodiment, the second magnetic suction region 12 is provided with five magnetic sheet groups including a second C-shaped magnetic sheet group 121, a second L-shaped magnetic sheet group 122, two vertical double-point magnetic sheet groups 123, and a second rectangular magnetic sheet group 124 in sequence from top to bottom. The second C-shaped magnetic sheet group 121 has a total of five magnetic sheets which are open down; the second L-shaped magnetic sheet group 122 is provided with three magnetic sheets horizontally and two magnetic sheets vertically, two of which are overlapped at an intersection, namely, a total of four magnetic sheets; each vertical double-point magnetic sheet group 123 includes two magnetic sheets; and the second rectangular magnetic sheet group 124 has the same number and distribution of magnetic sheets as the first rectangular magnetic sheet group. The second C-shaped magnetic sheet group, the second L-shaped magnetic sheet group, the two vertical double-point magnetic sheet groups, and the second rectangular magnetic sheet group are in one-to-one correspondence with magnetic suction components in the right side of the support plate 41.

The third magnetic suction region 13 is also provided with five magnetic sheet groups including a third C-shaped magnetic sheet group 131, a third L-shaped magnetic sheet group 132, two horizontal double-point magnetic sheet groups 133, and a third rectangular magnetic sheet group 134 in sequence from left to right. After the adaptive shell body 1 is clockwise rotated 90°, the third C-shaped magnetic sheet group 131 corresponds to the second C-shaped magnetic sheet group 121, the third L-shaped magnetic sheet group 132 corresponds to the second L-shaped magnetic sheet group 122, the two horizontal double-point magnetic sheet groups 133 correspond to the two vertical double-point magnetic sheet groups 123, and the third rectangular magnetic sheet group 134 corresponds to the second rectangular magnetic sheet group 124. As a result, when the adaptive shell body 1 rotates clockwise to be in a vertical state and is magnetically sucked onto the support plate 41, a main magnetic sheet region of the third magnetic suction region 13 in one-to-one correspondence with the magnetic suction component on the right side of the support plate 41, and the adaptive shell body 1 is better sucked to the support plate 41, thereby improving the firmness of magnetic suction of the tablet computer 2 onto the external tablet keyboard 4 in the portrait mode.

The third magnetic suction region 13 is further provided with an auxiliary magnetic sheet region 135, where the auxiliary magnetic sheet region 135 is next to a left side of the third C-shaped magnetic sheet group 131 and can be configured to enhance the magnetic suction strength for the requirements of some products.

As shown in FIG. 4, in this embodiment, a stylus slot 15 is arranged on the long side edge of the adaptive shell body 1 and located on one side of the third magnetic suction region 13. After the tablet computer 2 is magnetically sucked onto the external tablet keyboard 4 in the landscape mode, the stylus slot 15 is exactly located at an upper end thereof, making it convenient for a user to take and place a stylus 3 during operation.

It can be seen that each of the first magnetic suction region 11, the second magnetic suction region 12, and the third magnetic suction region 13 includes a plurality of magnetic sheets. According to the present utility model, a structure with small magnetic sheets distributed is used to form the magnetic suction region in one-to-one correspondence with the magnetic suction component inside the support plate 41, which can save consumables while meeting the requirements of the magnetic suction firmness.

### Embodiment 2

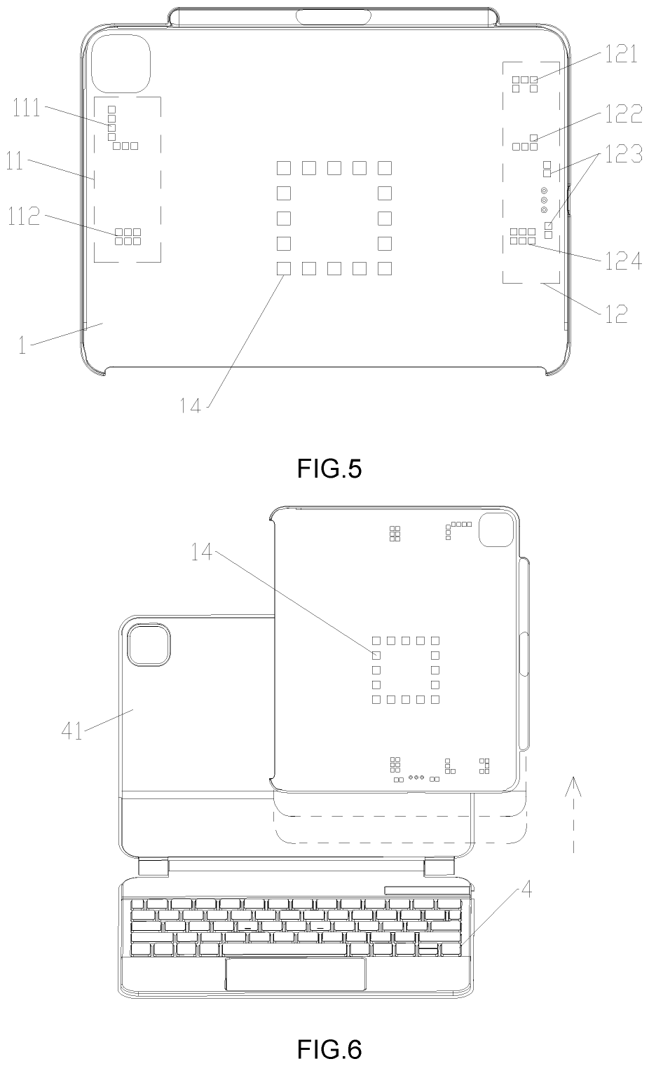

As shown in FIG. 5, an adaptive shell for an external tablet keyboard includes an adaptive shell body 1, where a first magnetic suction region 11 and a second magnetic suction region 12 are arranged on two short side edges of the adaptive shell body 1, respectively; the adaptive shell body 1 is further provided with a fourth magnetic suction region 14, the fourth magnetic suction region 14 being arranged in a middle of the adaptive shell body 1; when a tablet computer 2 is magnetically sucked onto an external tablet keyboard 4 in a landscape mode by the adaptive shell body 1, the first magnetic suction region 11 and the second magnetic suction region 12 are correspondingly connected to magnetic suction components on a left side and a right side of a support plate 41, respectively; or when a tablet computer 2 is magnetically sucked onto an external tablet keyboard 4 in a portrait mode by the adaptive shell body 1, a magnetic sheet on a right side of the fourth magnetic suction region 14 after clockwise rotation at 90° is connected to a magnetic suction component on a right side of a support plate 41.

In this embodiment, magnetic sheets in the fourth magnetic suction region 14 are symmetrically distributed, and a gap is reserved between adjacent two of the magnetic sheets, to form a plurality of equally spaced magnetic suction adjustment regions, such that a fixed magnetic suction height of the tablet computer 2 in the portrait mode on the support plate 41 can be adjusted by adjusting relative positions of the fourth magnetic suction region 14 and the magnetic suction component of the support plate 41.

In this embodiment, the magnetic sheets in the fourth magnetic suction region 14 are rectangularly distributed, and each edge thereof includes five magnetic sheets. The number of magnetic sheets on each edge of the fourth magnetic suction region 14 can be changed based on actual needs according to requirements for product sizes and corresponding magnetic suction forces, and may be four, six, etc.

In other optional embodiments, the magnetic sheets in the fourth magnetic suction region 14 are circularly distributed. The circular fourth magnetic suction region 14 is applicable to a product provided with a circular magnetic suction component at the support plate 41 of the external tablet keyboard 4. The structure can implement the rotation of the adaptive shell on the support plate 41 with the fourth magnetic suction region 14 as a center, so as to adjust an inclination angle of the tablet computer 2 on the support plate 41.

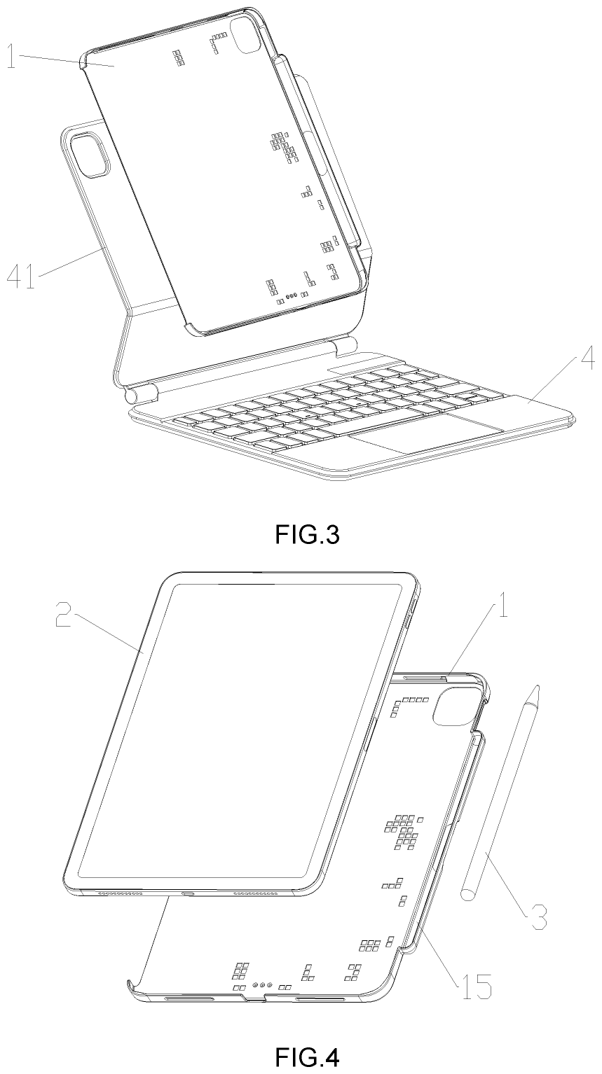

Through comparison, two solutions in Embodiment 1 and Embodiment 2 can both achieve the effect that the adaptive shell body is magnetically sucked onto the support plate in the portrait mode. There is a difference that in Embodiment 1, when the adaptive shell body is magnetically sucked in the portrait mode, the adaptive shell body can be located in the middle of the support plate; and in Embodiment 2, when the adaptive shell body is magnetically sucked in the portrait mode, the adaptive shell body is located on the right side of the support plate. Reference is made to FIG. 3 and FIG. 6.

### Embodiment 3

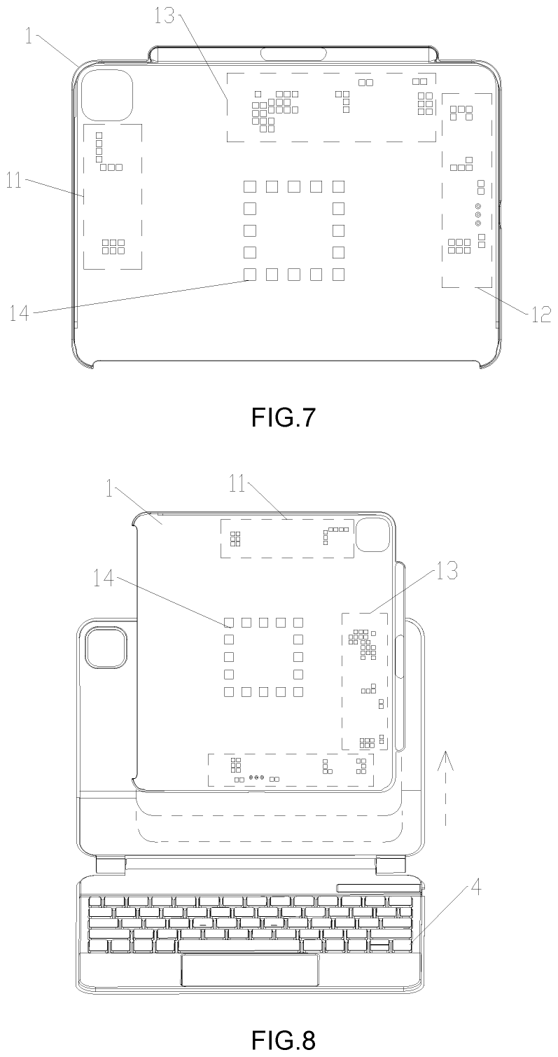

As shown in FIG. 7 and FIG. 8, an adaptive shell for an external tablet keyboard includes an adaptive shell body 1, where a first magnetic suction region 11 and a second magnetic suction region 12 are arranged on two short side edges of the adaptive shell body 1, respectively; the adaptive shell body 1 is further provided with a third magnetic suction region 13 and a fourth magnetic suction region 14, third magnetic suction region 13 being arranged on one long side edge of the adaptive shell body 1, the fourth magnetic suction region 14 being arranged in a middle of the adaptive shell body 1; when a tablet computer 2 is magnetically sucked onto an external tablet keyboard 4 in a landscape mode by the adaptive shell body 1, the first magnetic suction region 11 and the second magnetic suction region 12 are correspondingly connected to magnetic suction components on a left side and a right side of a support plate 41, respectively, and the fourth magnetic suction region 14 is connected to a magnetic suction component in a middle of the support plate 41; or when a tablet computer 2 is magnetically sucked onto an external tablet keyboard 4 in a portrait mode by the adaptive shell body 1, the third magnetic suction region 13 is connected to a magnetic suction component on a right side of a support plate 41, and the fourth magnetic suction region 14 is connected to a magnetic suction component in a middle of the support plate 41.

This embodiment is applicable to the case where the magnetic suction component is also arranged in the middle of the support plate 41. In this case, the fourth magnetic suction region 14 is configured to increase a magnetic suction force between the adaptive shell body 1 and the support plate 41.

In summary, according to the present utility model, the third magnetic suction region is additionally arranged on the long side edge of the adaptive shell and can be connected to the right side of the support plate of the external keyboard in a magnetic suction manner, such that the adaptive shell can also be connected to the external keyboard in a magnetic suction manner in a vertical state, thereby implementing the magnetic suction of the adaptive shell onto the existing external tablet keyboard in both the landscape mode and the portrait mode; moreover, the fourth magnetic suction region is additionally arranged to adapt to the external keyboard with the magnetic suction component arranged in the middle of the support plate, which improves the applicability of the adaptive shell according to the present utility model, thereby meeting the requirements of various external keyboards.

The technical features of the above embodiments may be combined arbitrarily. For the sake of brevity, all possible combinations of the technical features in the above embodiments are not described. However, the combinations of these technical features should be considered to be within the scope of this specification as long as there is no contradiction between them.

The above embodiments only express several implementations of the present utility model and are described more specifically and detailedly, but should not be construed as a limitation to the scope of the patent of the utility model. It should be pointed out that several modifications and improvements may also be made by those of ordinary skill in the art without departing from the conception of the present utility model, and all fall within the scope of protection of the present utility model. Therefore, the scope of protection of the patent of the present utility model should be determined by the appended claims.

What is claimed is:

1. An adaptive shell for an external tablet keyboard, comprising an adaptive shell body, wherein a back surface of the adaptive shell body is connected to a support plate of an external tablet keyboard in a magnetic suction manner; a first magnetic suction region and a second magnetic suction region are arranged on two short side edges of the adaptive shell body, respectively;
the adaptive shell body is further provided with a third magnetic suction region and/or a fourth magnetic suction region, the third magnetic suction region being arranged on one long side edge of the adaptive shell body, the fourth magnetic suction region being arranged in a middle of the adaptive shell body;
when a tablet computer is magnetically sucked onto the external tablet keyboard in a landscape mode by the adaptive shell body, the first magnetic suction region and the second magnetic suction region are correspondingly connected to magnetic suction components on a left side and a right side of the support plate, respectively, or the fourth magnetic suction region is connected to a magnetic suction component in a middle of the support plate; or
when a tablet computer is magnetically sucked onto the external tablet keyboard in a portrait mode by the adaptive shell body, the third magnetic suction region is connected to a magnetic suction component on a right side of the support plate, or the fourth magnetic suction region is connected to a magnetic suction component in a middle or on a right side of the support plate.

2. The adaptive shell for an external tablet keyboard according to claim 1, wherein the first magnetic suction region is provided with two magnetic sheet groups comprising a first L-shaped magnetic sheet group located above and a first rectangular magnetic sheet group located below.

3. The adaptive shell for an external tablet keyboard according to claim 1, wherein the second magnetic suction region is provided with five magnetic sheet groups comprising a second C-shaped magnetic sheet group, a second L-shaped magnetic sheet group, two vertical double-point magnetic sheet groups, and a second rectangular magnetic sheet group in sequence from top to bottom.

4. The adaptive shell for an external tablet keyboard according to claim 3, wherein the third magnetic suction region comprises a main magnetic sheet region and an auxiliary magnetic sheet region; the main magnetic sheet region is provided with five magnetic sheet groups comprising a third C-shaped magnetic sheet group, a third L-shaped magnetic sheet group, two horizontal double-point magnetic sheet groups, and a third rectangular magnetic sheet group in sequence from left to right; and the auxiliary magnetic sheet region is located on a left side of the third C-shaped magnetic sheet group.

5. The adaptive shell for an external tablet keyboard according to claim 4, wherein a magnetic sheet distribution of the main magnetic sheet region of the third magnetic suction region after clockwise rotation at 90° is in one-to-one correspondence with a magnetic sheet distribution of the second magnetic suction region.

6. The adaptive shell for an external tablet keyboard according to claim 1, wherein magnetic sheets in the fourth magnetic suction region are symmetrically distributed, and a gap is reserved between adjacent two of the magnetic sheets, to form a plurality of equally spaced magnetic suction adjustment regions.

7. The adaptive shell for an external tablet keyboard according to claim 6, wherein the magnetic sheets in the fourth magnetic suction region are rectangularly distributed, and each edge of the fourth magnetic suction region distributed rectangularly comprises five magnetic sheets.

8. The adaptive shell for an external tablet keyboard according to claim 1, wherein magnetic sheets in the fourth magnetic suction region are circularly distributed.

9. The adaptive shell for an external tablet keyboard according to claim 1, wherein a stylus slot is arranged on the long side edge of the adaptive shell body and located on one side of the third magnetic suction region.
